(19) United States
(12) Patent Application Publication
(10) Pub. No.: US 2016/0116945 A1
(43) Pub. Date: Apr. 28, 2016

(54) ELECTRONIC DEVICE WITH STORABLE KEYBOARD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YAN GUO, Shenzhen (CN)

(21) Appl. No.: 14/578,740

(22) Filed: Dec. 22, 2014

(30) Foreign Application Priority Data
Oct. 27, 2014 (CN) 201410580545.4

(51) Int. Cl. G06F 1/16

(52) U.S. Cl. CPC G06F 1/1662; G06F 1/1656

(57) ABSTRACT

An electronic device with a storable keyboard includes an electronic device, a casing enclosing the electronic device, and a keyboard. The keyboard is couplable to the electronic device to provide electronic input to the electronic device. The casing includes a defined space for storing the keyboard.

### CROSS-REFERENCE TO RELATED APPLICATIONS

This application claims priority to Chinese Patent Application No. 201410580545.4 filed on Oct. 27, 2014, the contents of which are incorporated by reference herein.

### FIELD

The subject matter herein generally relates to electronic devices having a embedded keyboard.

### BACKGROUND

Electronic devices, such as tablet personal computers, usually employ touch input screens as input devices. But in some cases, a physical keyboard may be also needed.

### BRIEF DESCRIPTION OF THE DRAWINGS

Implementations of the present technology will now be described, by way of example only, with reference to the attached figures.

FIG. 1 is a diagrammatic view illustrating an example embodiment of an electronic device with a storable keyboard.

FIG. 2 is an exploded view of an example embodiment of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. Also, the description is not to be considered as limiting the scope of the embodiments described herein.

The term “comprising” means “including, but not necessarily limited to”, it specifically indicates open-ended inclusion or membership in a so-described combination, group, series and the like.

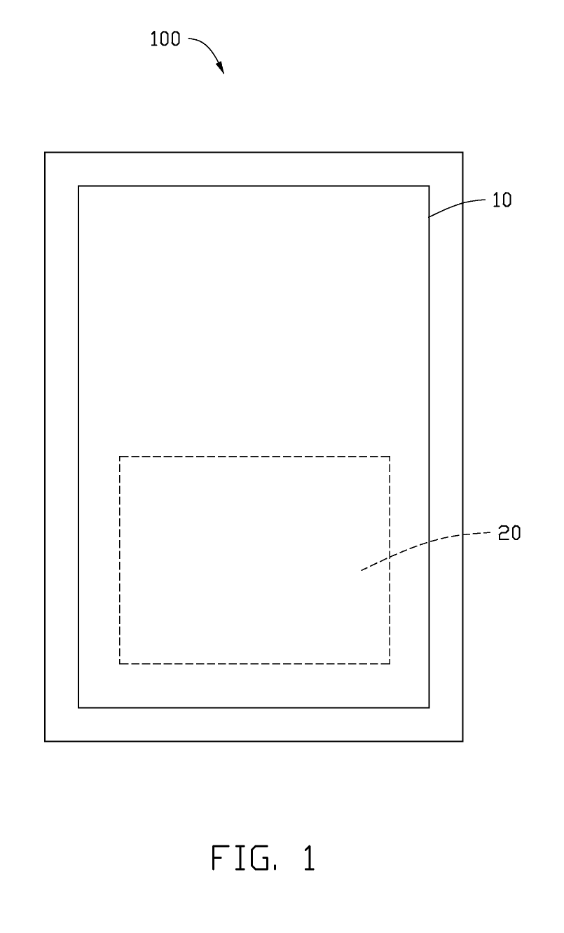

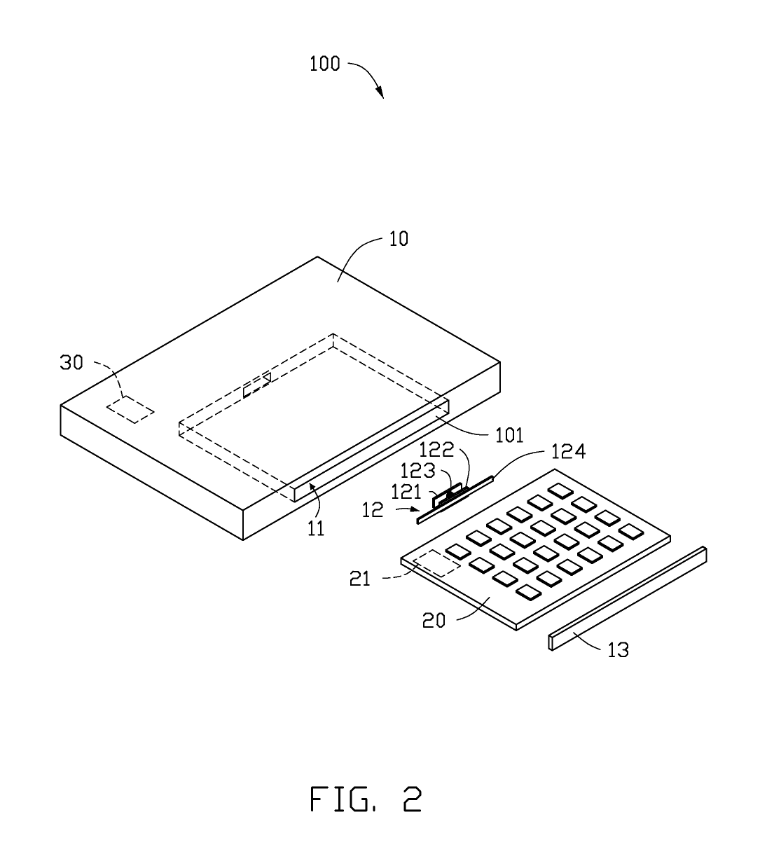

FIG. 1 illustrates a diagrammatic view of an example embodiment of an electronic device 100 with a storable keyboard 20. The electronic device 100 can be a mobile phone, a tablet computer, or the like. In at least one embodiment, the electronic device 100 can include a casing 10. FIG. 2 illustrates that the casing 10 defines a receiving space 11 for storing the keyboard 20. When the keyboard 20 is not used by a user, the keyboard 20 can be stored in the receiving space 11. When the user needs to use the keyboard 20, the keyboard 20 can be taken out of the receiving space 10, and is coupled to the electronic device 100 to provide electronic input to the electronic device 100. In this embodiment, the keyboard 20 is coupled to the electronic device 100 wirelessly. In this embodiment, the electronic device 100 can also include various other components enclosed by the casing to achieve functions of the electronic device 100. The components are not shown since the components are not the point of the disclosure.

In this embodiment, the keyboard 20 can be a mechanical keyboard 20. In other embodiments, the keyboard 20 can be a flexible touch keyboard.

In the embodiment, the receiving space 11 is a cavity defined inside of the casing 10, the shape of the receiving space 11 matches with the shape of the keyboard 20. One side of the casing 10 defines an opening 101. The receiving space 11 communicates with the opening 101. The keyboard 20 can be inserted into the receiving space 11 via the opening 101. The casing 10 can further include a cover 13. The cover 13 is detachably mounted to the casing 10 to cover the opening 101. When the keyboard 20 is received in the receiving space 11, the cover 13 covers the opening 101 to protect the keyboard 20 from contaminants like dust.

An ejecting switch 12 is mounted inside of the receiving space 11 to eject the keyboard 20 out of the receiving space 11. In this embodiment, the ejecting switch 12 can include an electromagnet 121, a magnetic element 122, an elastic member 123, and a pushing element 124. The electromagnet 121 is fixed to a sidewall of the receiving space 11. For example, as shown in FIG. 2, the electromagnet 121 can be fixed to a position of the dotted box shown in the inner sidewall of the receiving space 11. The electromagnet 121 is connected to a circuit (not shown) of the electronic device 100, the circuit provides electricity for the electromagnet 121. The magnetic element 122 can be metal, magnet, or the like. The elastic member 123 is connected between the electromagnet 121 and the magnetic element 122. The pushing element 124 is connected to the magnetic element 122 and faces the opening 101. When pushing the keyboard 20 into the receiving space 11, the pushing element 124 and the magnetic element 122 are driven by the keyboard 20 to move toward the electromagnet 121 until the magnetic element 122 attracts to the electromagnet 121, and the elastic member 123 is compressed. When the user needs to use the keyboard 20, the user can cut off the electricity provided to the electromagnet 121 by operating a switch (not shown) mounted on the electronic device 100 or by running a software application (not shown) installed in the electronic device 100. When the electricity provided to the electromagnet 121 is cut off, the attraction between the electromagnet 121 and the magnetic element 122 disappears, thus an elastic restoring force of the compressed elastic member 123 moves the magnetic element 122 and the pushing element 124 toward the opening 101, meanwhile, the pushing element 124 pushes the keyboard 20 out of the receiving space 11. In other embodiments, the function of the ejecting switch 12 can be achieved by other structures.

In this embodiment, a first communication unit 21 is mounted in the keyboard 20, a second communication unit 30 is mounted in the casing 10. The first communication unit 21 can communicate with the second communication unit 30 to transmit signals between the keyboard 20 and the electronic device 100 to enable the keyboard 20 to control the electronic device 100. In this embodiment, the first communication unit 21 communicates with the second communication unit 30 by BLUETOOTH.

The embodiments shown and described above are only examples. Many further details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device with a storable keyboard comprising:
an electronic device;
a casing enclosing the electronic device;
a keyboard; and
wherein, the keyboard is couplable to the electronic device to provide electronic input to the electronic device; and
wherein, the casing includes a defined space for storing the keyboard.

2. The electronic device of claim 1, wherein the keyboard is a flexible keyboard.

3. The electronic device of claim 1, wherein an ejecting switch is mounted inside the defined space to eject the keyboard out of the defined space.

4. The electronic device of claim 3, wherein the ejecting switch comprises a electromagnet, a magnetic element, an elastic member, and a pushing element; the electromagnet is fixed to a sidewall of the receiving space; the elastic member is connected between the electromagnet and the magnetic element; the pushing element is connected to the magnetic element.

5. The electronic device of claim 1, wherein a first communication unit is mounted in the keyboard, a second communication unit is mounted in the casing; the first communication unit communicates with the second communication unit to transmit signals between the keyboard and the electronic device to enable the keyboard to control the electronic device.

6. The electronic device of claim 5, wherein the first communication unit communicates with the second communication unit by BLUETOOTH.

7. The electronic device of claim 1, wherein an opening is defined in a sidewall of the casing, the opening communicates with the defined space, a cover is detachable mounted on the casing to cover the opening.
